(19) United States
(12) Patent Application Publication
(10) Pub. No.: US 2022/0157021 A1
(43) Pub. Date: May 19, 2022

(54) PARK MONITORING METHODS, PARK MONITORING SYSTEMS AND COMPUTER-READABLE STORAGE MEDIA

(71) Applicant: BOE Technology Group Co., Ltd., Beijing (CN)

(72) Inventors: Hongda YU, Beijing (CN); Haijun FAN, Beijing (CN); Di WU, Beijing (CN); Dahai HOU, Beijing (CN); Chu CHU, Beijing (CN)

(21) Appl. No.: 17/359,493

(22) Filed: Jun. 25, 2021

(30) Foreign Application Priority Data
Nov. 18, 2020 (CN) 202011295832.2

(51) Int. Cl. G06T 19/00; G08G 1/137; G06T 19/20; H04N 7/18; G01C 21/36

(52) U.S. Cl. CPC G06T 19/003; G08G 1/137; G06T 19/20; G06T 2219/2016; H04N 7/181; G01C 21/3635; G06T 19/006

(57) ABSTRACT

Park monitoring methods, park monitoring systems, and computer-readable storage media are provided. A method includes: determining a first path from a current position of a first object to a first position; generating a 3D virtual image of a surrounding environment when the first object is moving along the first path based on a perspective of the first object; and when the first object is located at the first position, displaying a real image of the first position.

### CROSS-REFERENCE TO RELATED APPLICATIONS

The present disclosure claims a priority of the Chinese patent application No. 202011295832.2 filed on Nov. 18, 2020 and entitled “PARK MONITORING METHODS AND PARK MONITORING APPARATUSES”, which is incorporated herein by reference in its entirety.

### TECHNICAL FIELD

The present disclosure relates to the field of display technology, and in particular to a park monitoring method, a park monitoring system, and a computer-readable storage medium.

### BACKGROUND

In the related art, scenarios may be displayed either through 3D virtual images or through real images, without a reasonable combination of the 3D virtual images and the real images. In some application scenarios, it may be difficult to achieve a good display effect.

### SUMMARY

The present disclosure provides a park monitoring method, a park monitoring system, and a computer-readable storage medium.

According to a first aspect of embodiments of the present disclosure, there is provided a park monitoring method, including:

determining a first path from a current position of a first object to a first position;

generating a 3D virtual image of a surrounding environment when the first object is moving along the first path based on a perspective of the first object; and

when the first object is located at the first position, displaying a real image of the first position.

Optionally, the first object is a handler who handles an alarm event, and before determining the first path from the current position of the first object to the first position, the method may further include:

when the alarm event is detected, displaying a 3D virtual image of an environment the alarm event is in, and displaying a mark for the alarm event in the 3D virtual image of the environment the alarm event is in;

when a first command is received, displaying a 3D virtual image at the first position; and

when a second command is received, determining the handler and a second position of the handler, and

where, determining the first path from the current position of the first object to the first position may include:

determining a path from the second position to the first position as the first path.

Optionally, displaying the 3D virtual image of the first position may include:

determining a second path from a third position where a current monitoring perspective is to the first position; and

generating a 3D virtual image of a surrounding environment when moving along the second path based on the current monitoring perspective, until a 3D virtual image of a surrounding environment at the first position is displayed.

Optionally, displaying the 3D virtual image of the first position may include:

in the 3D virtual image of the environment the alarm event is in, cutting, splitting, and enlarging a building where the alarm event is located, to display the 3D virtual image of the first position.

Optionally, the method may further include:

when the first position changes with time, recording a trajectory of the first position; and

determining a third position according to the trajectory, where the third position is a position on the trajectory or a predicted position of the first position; and

where, determining the first path from the current position of the first object to the first position may include:

determining a path from the second position to the third position as the first path.

Optionally, the method may further include:

determining a target perspective according to the trajectory of the first position; and

generating a 3D virtual image of a surrounding environment when moving along the trajectory based on the target perspective.

Optionally, displaying the real image of the first position may include:

fusing the real image of the first position in a 3D virtual image of the first position for display.

Optionally, the first object is a vehicle, and before determining the first path from the current position of the first object to the first position, the method may further include:

determining a target parking space in a parking lot and determining a position of the target parking space as the first position; and

where, determining the first path from the current position of the first object to the first position may include:

determining a path from a position of the vehicle to the first position as the first path.

Optionally, the method may further include:

recording and/or displaying a second object entering and exiting the vehicle, and a trajectory of the second object.

Optionally, the method may further include:

sending the 3D virtual image of the surrounding environment when the first object is moving along the first path to the first object.

Optionally, the method may further include:

recording the 3D virtual image of the surrounding environment when the first object is moving along the first path, and/or recording the real image of the first position when the first object is located at the first position.

According to a second aspect of the embodiments of the present disclosure, there is provided a park monitoring system, including:

a processor; and

a memory storing programming instructions for execution by the processor to perform operations including:

determining a first path from a current position of a first object to a first position;

generating a 3D virtual image of a surrounding environment when the first object is moving along the first path based on a perspective of the first object; and

when the first object is located at the first position, displaying a real image of the first position.

Optionally, the first object is a handler who handles an alarm event, and before determining the first path from the current position of the first object to the first position, the operations may further include:

when the alarm event is detected, displaying a 3D virtual image of an environment the alarm event is in, and displaying a mark for the alarm event in the 3D virtual image of the environment the alarm event is in;

when a first command is received, displaying a 3D virtual image of the first position; and

when a second command is received, determining the handler and a second position of the handler, and

where, determining the first path from the current position of the first object to the first position may include:

determining a path from the second position to the first position as the first path.

Optionally, displaying the 3D virtual image of the first position may include:

determining a second path from a third position where a current monitoring perspective is to the first position; and

generating a 3D virtual image of a surrounding environment when moving along the second path based on the current monitoring perspective, until a 3D virtual image of a surrounding environment at the first position is displayed.

Optionally, the operations may further include:

when the first position changes with time, recording a trajectory of the first position; and

determining a third position according to the trajectory, where the third position is a position on the trajectory or a predicted position of the first position; and

where, determining the first path from the current position of the first object to the first position may include:

determining a path from the second position to the third position as the first path.

Optionally, displaying the real image of the first position may include:

fusing the real image of the first position in a 3D virtual image of the first position for display.

Optionally, the first object is a vehicle, and before determining the first path from the current position of the first object to the first position, the operations may further include:

determining a target parking space in a parking lot and determining a position of the target parking space as the first position; and

where, determining the first path from the current position of the first object to the first position may include:

determining a path from a position of the vehicle to the first position as the first path.

Optionally, the operations may further include:

sending the 3D virtual image of the surrounding environment when the first object is moving along the first path to the first object.

Optionally, the operations may further include:

recording the 3D virtual image of the surrounding environment when the first object is moving along the first path, and/or recording the real image of the first position when the first object is located at the first position.

According to a third aspect of the embodiments of the present disclosure, there is provided a non-transitory computer-readable storage medium storing programming instructions for execution by a processor to perform operations including:

determining a first path from a current position of a first object to a first position;

generating a 3D virtual image of a surrounding environment when the first object is moving along the first path based on a perspective of the first object; and

when the first object is located at the first position, displaying a real image of the first position.

According to the above embodiments, a 3D virtual image of a surrounding environment when a first object moves along a first path may be displayed based on a perspective of the first object, and a real image of the first position may be displayed when the first object is located at the first position. During this process, the 3D virtual image may be displayed in combination with the real image.

It should be understood that the above general description and the following detailed description are merely exemplary and explanatory, and are not intended to limit the present disclosure.

### BRIEF DESCRIPTION OF THE DRAWINGS

In order to illustrate embodiments of the present disclosure more clearly, the accompanying drawings used in the description of the embodiments will be briefly introduced below. Obviously, the drawings in the following description merely illustrate some embodiments of the present disclosure. For those ordinary skilled in the art, other drawings may also be obtained from these drawings without any creative efforts.

FIG. 1 is a schematic flowchart illustrating a park monitoring method according to an embodiment of the present disclosure.

FIG. 2 is a schematic flowchart illustrating a park monitoring method according to another embodiment of the present disclosure.

FIG. 3 is a schematic flowchart illustrating a park monitoring method according to yet another embodiment of the present disclosure.

FIG. 4 is a schematic flowchart illustrating a park monitoring method according to yet another embodiment of the present disclosure.

FIG. 5 is a schematic flowchart illustrating a park monitoring method according to yet another embodiment of the present disclosure.

FIG. 6 is a schematic flowchart illustrating a park monitoring method according to yet another embodiment of the present disclosure.

FIGS. 7A to 7M are schematic diagrams illustrating an application scenario according to an embodiment of the present disclosure.

FIG. 8 is a schematic flowchart illustrating a park monitoring method according to yet another embodiment of the present disclosure.

FIG. 9 is a schematic flowchart illustrating a park monitoring method according to yet another embodiment of the present disclosure.

FIGS. 10A to 10G are schematic diagrams illustrating an application scenario according to another embodiment of the present disclosure.

FIG. 11 is a schematic flowchart illustrating a park monitoring method according to yet another embodiment of the present disclosure.

FIG. 12 is a schematic flowchart illustrating a park monitoring method according to yet another embodiment of the present disclosure.

FIG. 13 is a schematic block diagram illustrating a park monitoring apparatus according to an embodiment of the present disclosure.

FIG. 14 is a schematic block diagram illustrating a park monitoring apparatus according to another embodiment of the present disclosure.

FIG. 15 is a schematic block diagram illustrating a park monitoring apparatus according to yet another embodiment of the present disclosure.

FIG. 16 is a schematic block diagram illustrating a park monitoring apparatus according to yet another embodiment of the present disclosure.

FIG. 17 is a schematic block diagram illustrating a park monitoring apparatus according to yet another embodiment of the present disclosure.

FIG. 18 is a schematic block diagram illustrating a park monitoring apparatus according to yet another embodiment of the present disclosure.

FIG. 19 is a schematic block diagram illustrating a park monitoring apparatus according to yet another embodiment of the present disclosure.

### DETAILED DESCRIPTION OF THE EMBODIMENTS

Exemplary embodiments will be described in detail herein, and examples thereof are illustrated in the drawings. When the following description refers to the drawings, the same numbers in different drawings indicate the same or similar elements, unless otherwise indicated. Implementations described in the following exemplary embodiments do not represent all implementations in accordance with the present disclosure. Rather, they are merely examples of apparatuses and methods in accordance with some aspects of the present disclosure as detailed in the appended claims.

FIG. 1 is a schematic flowchart illustrating a park monitoring method according to an embodiment of the present disclosure. The park monitoring method may be applicable to a park monitoring system. The park monitoring system may be applied to scenarios such as buildings, parking lots, and office parks. The park monitoring system may include a plurality of image capturing devices such as cameras and video cameras. The image capturing devices may be provided at various positions in a scenario, capture images of the various positions in the scenario, and send the captured images to a processor of the park monitoring system. The processor may process the received images, for example, convert the received images into 3D virtual images.

As shown in FIG. 1, the park monitoring method may include the following steps S101-S103.

At step S101, a first path from a current position of a first object to a first position is determined.

At step S102, a 3D virtual image of a surrounding environment when the first object is moving along the first path is generated based on a perspective of the first object.

At step S103, a real image of the first position is displayed when the first object is located at the first position.

In an embodiment, the first object may be a person or an object, which may be determined according to an application scenario. When it is determined that the first object needs to move from its current position to the first position, the first path from the current position of the first object to the first position may be determined. An algorithm for planning the first path may be selected according to needs, for example, the first path may be planned through a NavMesh algorithm.

In an embodiment, the perspective of the first object may be determined based on a movement direction of the first object. For example, the perspective of the first object may be directed toward the movement direction of the first object, and be located at a preset height. For example, the first object is a person, and the preset height may be an eye height of an average-height adult, which may be, for example, 1.65 meters. For example, the first object is a vehicle, and the preset height may be a height where eyes of a driver of the vehicle are located.

An image of an environment at a real-time position may be captured by an image capturing device near the first path, and then the captured image of the environment may be converted into a 3D virtual image according to the perspective of the first object, thereby generating the 3D virtual image viewed from the perspective of the first object. During the movement of the first object along the first path, multi-frame 3D virtual images may be generated continuously, for example, the multi-frame 3D virtual images may be generated at preset time intervals. Continuous multi-frame 3D virtual images may form a 3D video, which is a simulation of a 3D virtual environment viewed from the perspective of the first object during the movement of the first object along the first path.

In an embodiment, the 3D video including the continuous multi-frame 3D virtual images may be provided to monitoring personnel for viewing, such that the monitoring personnel may intuitively understand a situation along the first path. The 3D video may also be provided to the first object for viewing. For example, the first object is a vehicle, and the 3D video may be sent to a driver of the vehicle, so as to provide the driver with an intuitive navigation.

Further, when the first object is located at the first position, the real image of the first position may be displayed, such that the monitoring personnel may intuitively and accurately view the behavior of the first object at the first position.

According to an embodiment of the present disclosure, a 3D virtual image of a surrounding environment when a first object is moving along a first path may be displayed based on a perspective of the first object, and a real image of the first position may be displayed when the first object is located at the first position. During this process, the 3D virtual image may be displayed in combination with the real image, which is convenient for monitoring personnel to intuitively understand a situation along the first path, and to intuitively and accurately view the behavior of the first object at the first position.

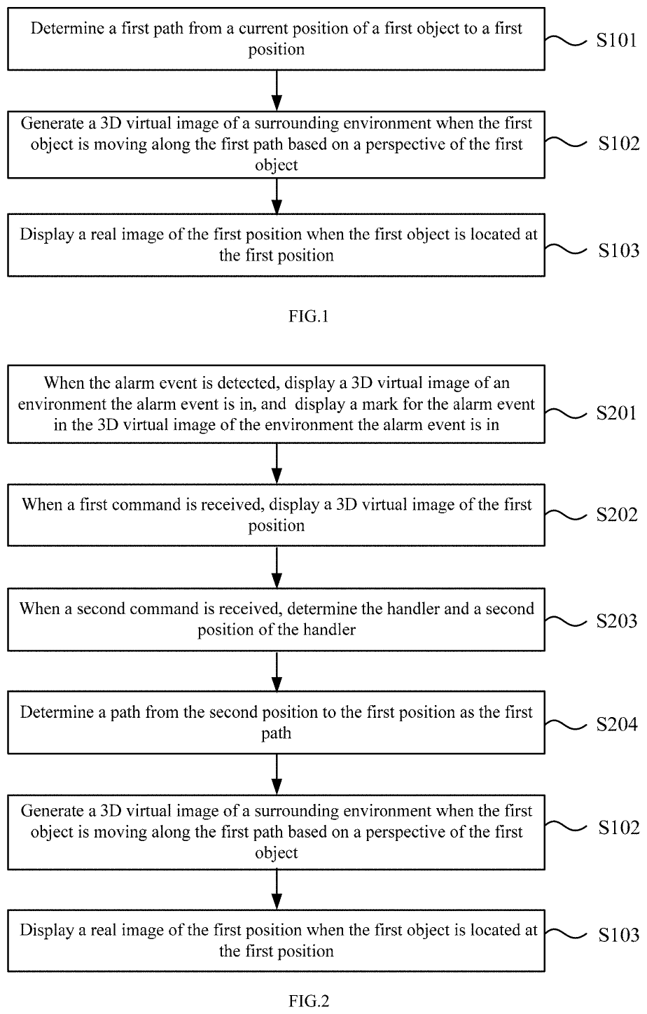

FIG. 2 is a schematic flowchart illustrating a park monitoring method according to another embodiment of the present disclosure. As shown in FIG. 2, the first object is a handler who handles an alarm event, and before determining the first path from the current position of the first object to the first position, the method may further include steps S201-S203.

At step S201, when the alarm event is detected, a 3D virtual image of an environment the alarm event is in is displayed, and a mark for the alarm event is displayed in the 3D virtual image of the environment the alarm event is in.

At step S202, when a first command is received, a 3D virtual image of the first position is displayed.

At step S203, when a second command is received, the handler and a second position of the handler are determined.

Where, determining the first path from the current position of the first object to the first position may include step S204. At step S204, a path from the second position to the first position is determined as the first path.

In an embodiment, the park monitoring method may be applicable to scenarios in which alarm events are handled. The alarm events include, but are not limited to, equipment abnormalities, occupation of a restricted area, wearing no masks, littering, abnormal workstations, irregular persons existing in an area, and vehicles staying overtime in an area, which need to be dealt with. The handler who handles the alarm event may be a person, or an object such as a robot.

There are many ways to detect the alarm events. For example, the alarm event is a smoke alarm, which may be alarmed by a smoke detector. For example, the alarm event is the occupation of the restricted area, and the image of the restricted area may be captured by an image capturing device, then the captured image may be recognized to identify whether there is an object in the restricted area.

When the alarm event is detected, the 3D virtual image of the environment the alarm event is in may be displayed, and the mark for the alarm event may be displayed in the 3D virtual image of the environment the alarm event is in. It should be noted that in an interface that displays the 3D virtual image, other contents may be displayed in addition to the first position. For example, prompt information of the alarm event may be displayed in the form of a 2D image, and the first position may be highlighted, such that the monitoring personnel may operate according to the prompt information.

In an embodiment, the monitoring personnel may input the first command by clicking the prompt information or clicking the displayed first position, and the 3D virtual image of the first position may be displayed after the first command is received. A 3D virtual image within a first range near the first position may be displayed, such that the monitoring personnel may roughly understand a general situation near the first position, where the first range may be scaled as needed.

The displayed 3D virtual image may only include the 3D virtual image, or the real image of the first position may be further included on the basis of the 3D virtual image, for example, the real image may be fused in the 3D virtual image of the first position for display. For example, an area involved in the 3D virtual image of the first position includes multiple rooms, and the first position is located in a target room of the multiple rooms, in this case, a real image in the target room may be captured by an image capturing device in the target room, and then the real image is fused in a position of the target room in the 3D virtual image for display, such that the monitoring personnel may intuitively and accurately check whether there is an alarm event at the first position and the severity of the alarm event.

Next, the monitoring personnel may also input the second command, for example, by clicking a virtual button in the interface, such as a matching handler button, such that the handler who handles the alarm event and the second position of the handler may be determined. The method of determining the handler may be set as needed. For example, a handler of a plurality of handlers who is closest to the second position may be determined as the handler who handles the alarm event, or a handler of a plurality of handlers who is available may be determined as the handler who handles the alarm event. Then, the path from the second position to the first position may be determined as the first path.

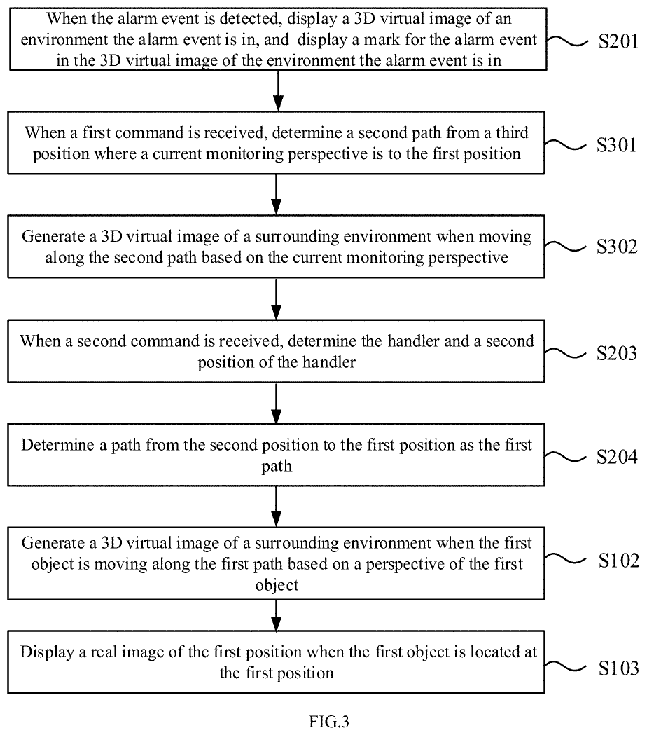

FIG. 3 is a schematic flowchart illustrating a park monitoring method according to yet another embodiment of the present disclosure. As shown in FIG. 3, displaying the 3D virtual image of the first position may include steps S301 and S302.

At step S301, a second path from a third position where a current monitoring perspective is to the first position is determined.

At step S302, a 3D virtual image of a surrounding environment when moving along the second path is generated based on the current monitoring perspective.

In an embodiment, the second path from the third position where the current monitoring perspective is to the first position may be determined, and then the 3D virtual image of the surrounding environment when moving along the second path is generated based on the current monitoring perspective, until a 3D virtual image of a surrounding environment at the first position is displayed, such that the monitoring personnel may understand a situation along the second path to the first position. Multi-frame 3D virtual images may be generated continuously, and the continuous multi-frame 3D virtual images may form a 3D video, which is a simulation of a 3D virtual environment viewed from the current monitoring perspective during the movement from the third position along the second path.

The current monitoring perspective may be a perspective of an image displayed on the current interface, which may be a perspective of a specific image capturing device, or a virtual perspective, such as a perspective in the air. The second path may be a virtual path, which does not have to be provided to the monitoring personnel or the handler.

FIG. 4 is a schematic flowchart illustrating a park monitoring method according to yet another embodiment of the present disclosure. As shown in FIG. 4, displaying the 3D virtual image of the first position may include step S401.

At step S401, in the 3D virtual image of the environment the alarm event is in, a building where the alarm event is located is cut, split and enlarged, to display the 3D virtual image of the first position.

In an embodiment, the building where the alarm event is located may be cut, split, and enlarged in the 3D virtual image of the environment the alarm event is in. For example, if the alarm event is located on the third floor of Building B of a building group, the Building B may be first cut out from the building group, and then the third floor may be split from the Building B cut out, and a position where the alarm event is located on the third floor may be enlarged, to display the 3D virtual image of the first position where the alarm event is located, such that the monitoring personnel may intuitively view a situation at the first position. The method of splitting may be set according to needs, for example, the third floor of the Building B may be highlighted, and then the building structure from the third floor upwards may be stripped.

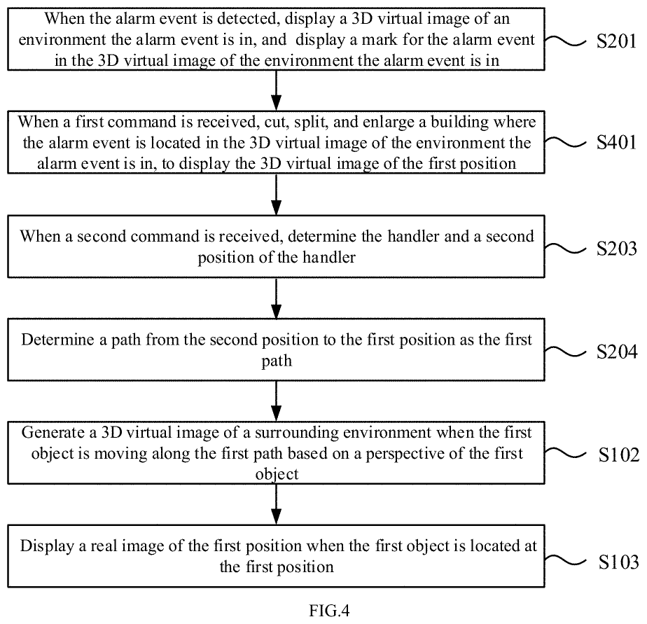

FIG. 5 is a schematic flowchart illustrating a park monitoring method according to yet another embodiment of the present disclosure. As shown in FIG. 5, the method may further include steps S501-S502.

At step S501, when the first position changes with time, a trajectory of the first position is recorded.

At step S502, a third position is determined according to the trajectory, where the third position is a position on the trajectory or a predicted position of the first position.

Where, determining the first path from the current position of the first object to the first position may include step S503.

At step S503, a path from the second position to the third position is determined as the first path.

In an embodiment, in some cases, the first position where the alarm event is located may change with time. For example, the alarm event is that there is an irregular person in the park, that is, an unauthorized person moves irregularly in the park, and in this case, the first position of the person is changing.

In this case, the trajectory of the first position may be recorded, and then the third position may be determined according to the trajectory. The third position may be a position on the trajectory or a predicted position of the first position. Then, the path from the second position to the third position may be provided as the first path to the handler for navigation, such that the handler may accurately reach the first position.

When the third position is the predicted position of the first position, a movement speed may be determined according to the trajectory of the first position, and then the first position in the next period of time may be predicted according to the movement speed and a movement direction, for example. In this case, the determined first path may be a first path from the second position to the predicted position of the first position, such that the handler may be instructed to accurately reach the position where the irregular person will arrive based on the first path.

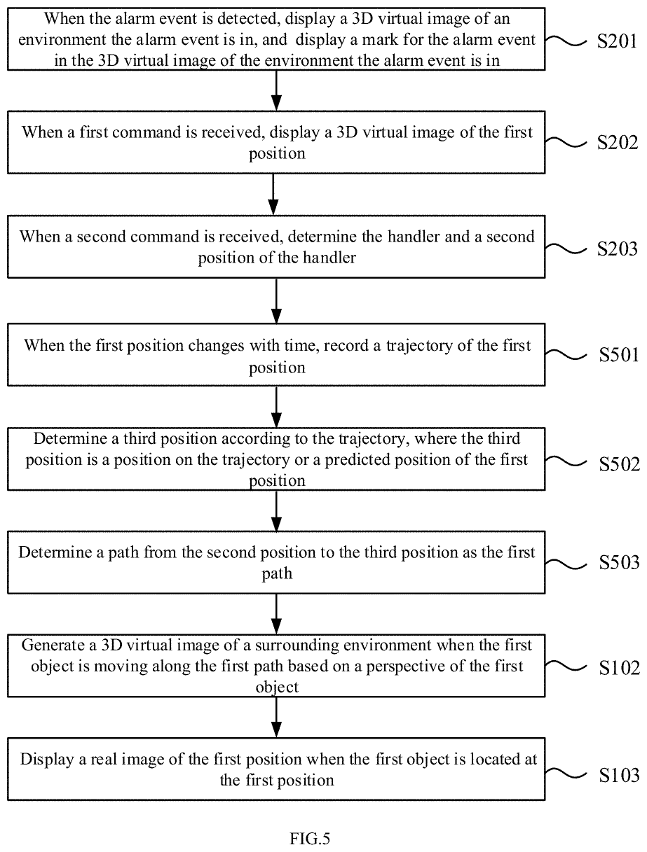

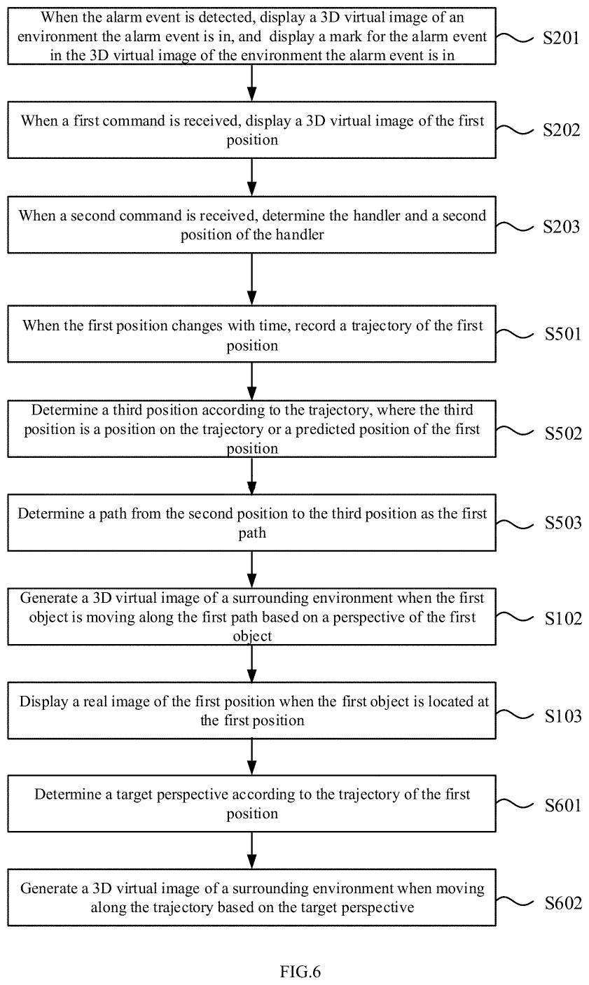

FIG. 6 is a schematic flowchart illustrating a park monitoring method according to yet another embodiment of the present disclosure. As shown in FIG. 6, the method may further include steps S601 and S602.

At step S601, a target perspective is determined according to the trajectory of the first position.

At step S602, a 3D virtual image of a surrounding environment when moving along the trajectory is generated based on the target perspective.

In an embodiment, the target perspective may be determined according to the trajectory of the first position. For example, the target perspective may be directed toward the movement direction of the trajectory, and a height of the target perspective may be an eye height. Then, the 3D virtual image of the surrounding environment when moving along the trajectory may be generated based on the target perspective, so as to facilitate understanding of a situation of the irregular person during movement. Multi-frame 3D virtual images may be generated continuously, and the continuous multi-frame 3D virtual images may form a 3D video, which is a simulation of the 3D virtual environment viewed from the target perspective during the movement along the trajectory of the first position.

Optionally, displaying the real image of the first position may include:

fusing the real image of the first position in a 3D virtual image of the first position for display.

In an embodiment, when the first object is located at the first position, the real image of the first position may be fused and displayed in the 3D virtual image of the first position. For example, an area involved in the 3D virtual image of the first position includes multiple rooms, and the first position is located in a target room of the multiple rooms, in this case, a real image in the target room may be captured by an image capturing device in the target room, and then the real image is fused in a position of the target room in the 3D virtual image for display, while rooms other than the target room are still displayed as 3D virtual images, such that the monitoring personnel may accurately determine a spatial position of the target room based on the 3D virtual image, and intuitively and accurately view the behavior of the first object at the first position based on the real image.

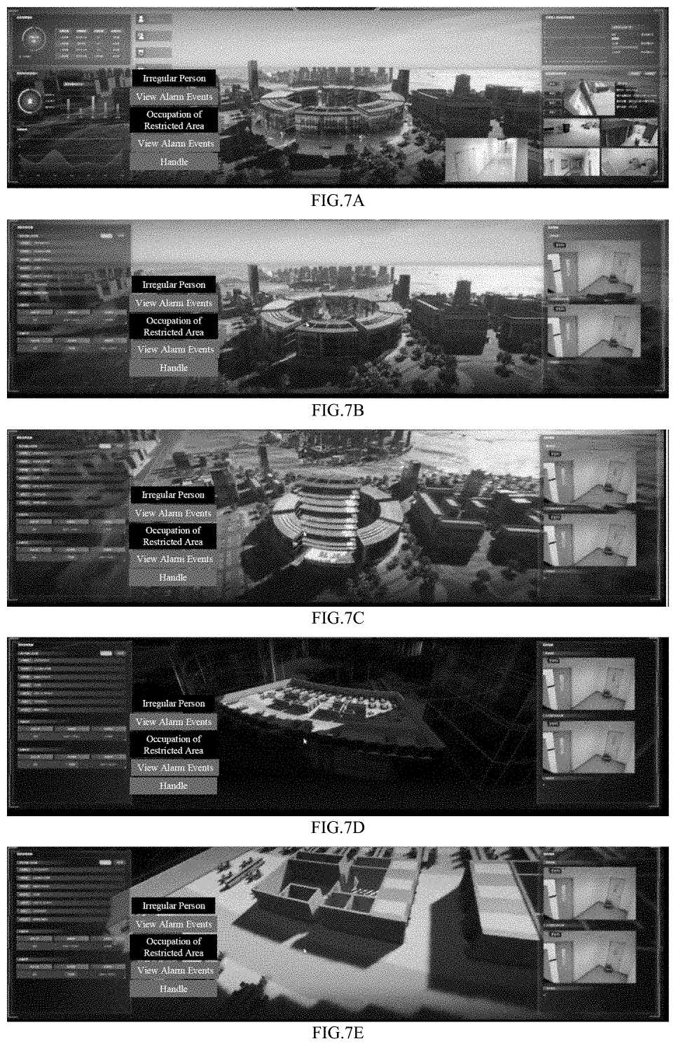

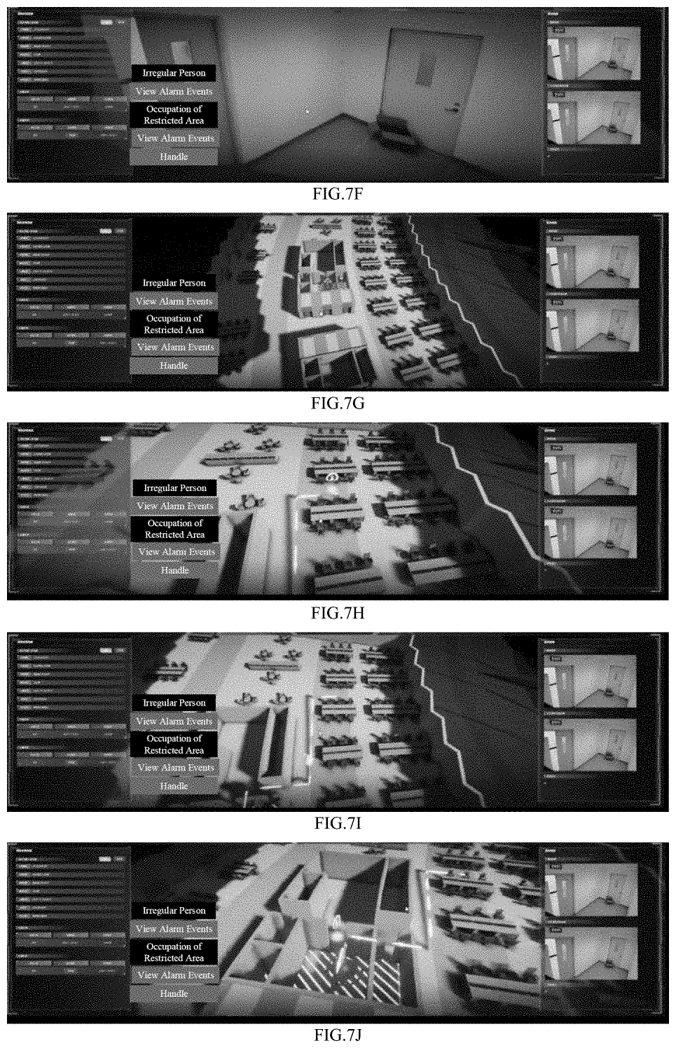

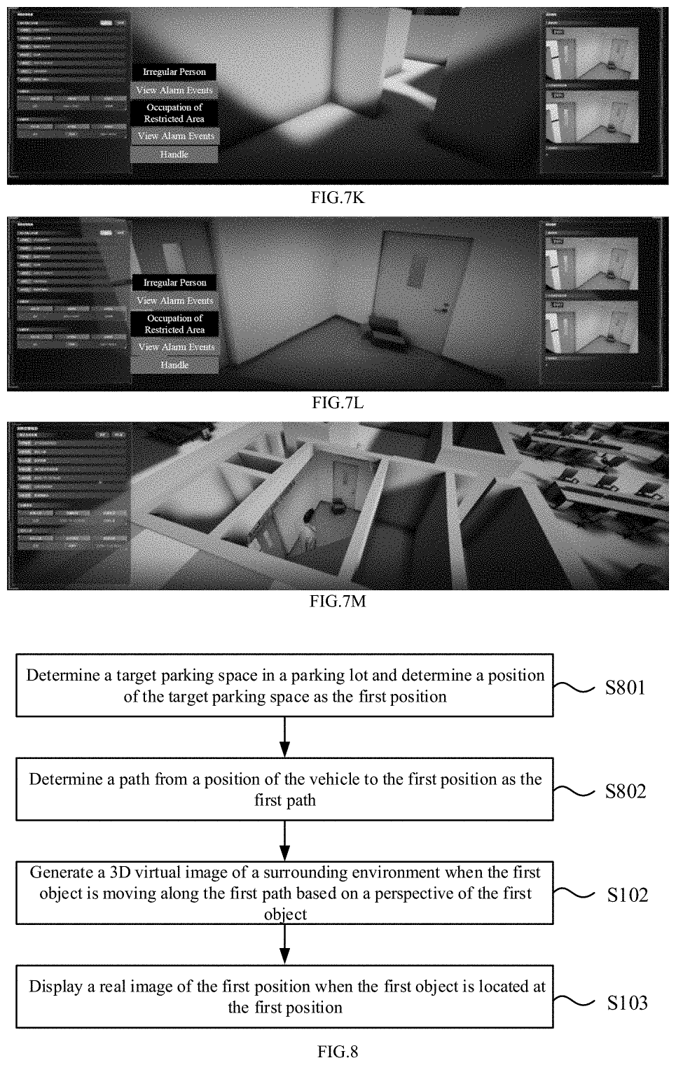

FIGS. 7A to 7M are schematic diagrams illustrating an application scenario according to an embodiment of the present disclosure.

As shown in FIG. 7A, a 3D virtual image of a park may be displayed on an interface. When an alarm event is detected, 2D virtual buttons may be displayed on the interface, for example, a button “View Alarm Events” may be displayed on the left side of the interface, and the type of the alarm event may be displayed as “Occupation of Restricted Area”, and a mark for the alarm event such as a triangle mark may be displayed in the 3D virtual image.

After a user clicks the button “View Alarm Events” in FIG. 7A, operations shown in FIGS. 7B to 7E may be performed sequentially. A building where the alarm event is located may be determined first (FIG. 7B), and the building may be cut out and split floor by floor (FIG. 7C) to obtain the floor where the alarm event is located, and then a position where the alarm event is located on the floor may be enlarged (FIGS. 7D and 7E), to display the 3D virtual image at the first position where the alarm event is located. For example, the first position is a position where the triangle mark is located in FIG. 7D and FIG. 7E, and the 3D virtual image at the position where the triangle mark is located may be displayed.

It should be noted that in FIGS. 7B to 7E, after the user clicks the button “View Alarm Events”, the real image of the first position may be displayed on the right side of the interface, such that the user may check whether there is an alarm event at the first position and the severity of the alarm event.

Then, as shown in FIG. 7F, the real image of the first position may be displayed, such that the user may accurately understand an actual situation at the first position.

Next, a handler (that is, the first object) who handles the alarm event may be determined, and a 3D virtual image of a surrounding environment when the handler is moving along the first path may also be generated based on the perspective of the handler. When the handler is moving along the first path, multi-frame 3D virtual images may be generated continuously, and the continuous multi-frame 3D virtual images may form a 3D video, which is a simulation of a 3D virtual environment viewed from the perspective of the handler during the movement of the handler along the first path. The generated 3D video may be sent to the handler to provide navigation for the handler.

Further, as shown in FIG. 7G, the 3D virtual image in the interface may be reduced first, and then the interface is displayed as moving to the vicinity of the handler, to display a 3D virtual environment around the handler as shown in FIG. 7H. The first path from the position of the handler to the first position may also be determined, as shown by a dashed line with an arrow in FIG. 7H. When the handler starts to move, the position of the handler may be displayed in the 3D virtual environment, as shown in FIGS. 71 and 7J. During the movement of the handler, a 3D virtual image may be generated based on the perspective of the handler, as shown in FIG. 7K. Finally, when the handler is located at the first position, a real image of the first position may be fused and displayed in the 3D virtual image of the first position, as shown in FIGS. 7L and 7M, in order for the user to view a specific process of the handler eliminating the alarm event, such as a process of removing a box as shown from a door.

FIG. 8 is a schematic flowchart illustrating a park monitoring method according to yet another embodiment of the present disclosure. As shown in FIG. 8, the first object is a vehicle, and before determining the first path from the current position of the first object to the first position, the method may further include step S801.

At step S801, a target parking space is determined in a parking lot and a position of the target parking space is determined as the first position.

Where, determining the first path from the current position of the first object to the first position may include step S802.

At step S802, a path from a position of the vehicle to the first position is determined as the first path.

In an embodiment, when the first object is a vehicle, the method may be applicable to a scenario where the vehicle enters a parking lot and parks. The target parking space and the first position of the target parking space may be determined in the parking lot, where the target parking space may be a vacant parking space, and further may be the closest parking space to the vehicle among vacant parking spaces. Then, the path from the position of the vehicle to the first position may be determined as the first path. Accordingly, the first path may be sent to a driver of the vehicle to provide navigation for the driver.

FIG. 9 is a schematic flowchart illustrating a park monitoring method according to yet another embodiment of the present disclosure. As shown in FIG. 9, the method may further include step S901.

At step S901, a second object entering and exiting the vehicle and a trajectory of the second object are recorded and/or displayed.

In an embodiment, the second object entering and exiting the vehicle may be recorded and displayed. The second object may include a person or an object. And the trajectory of the second object may also be recorded and displayed, such that the monitoring personnel may understand exactly who the second object entering and exiting the vehicle is, where the second object will go and other information.

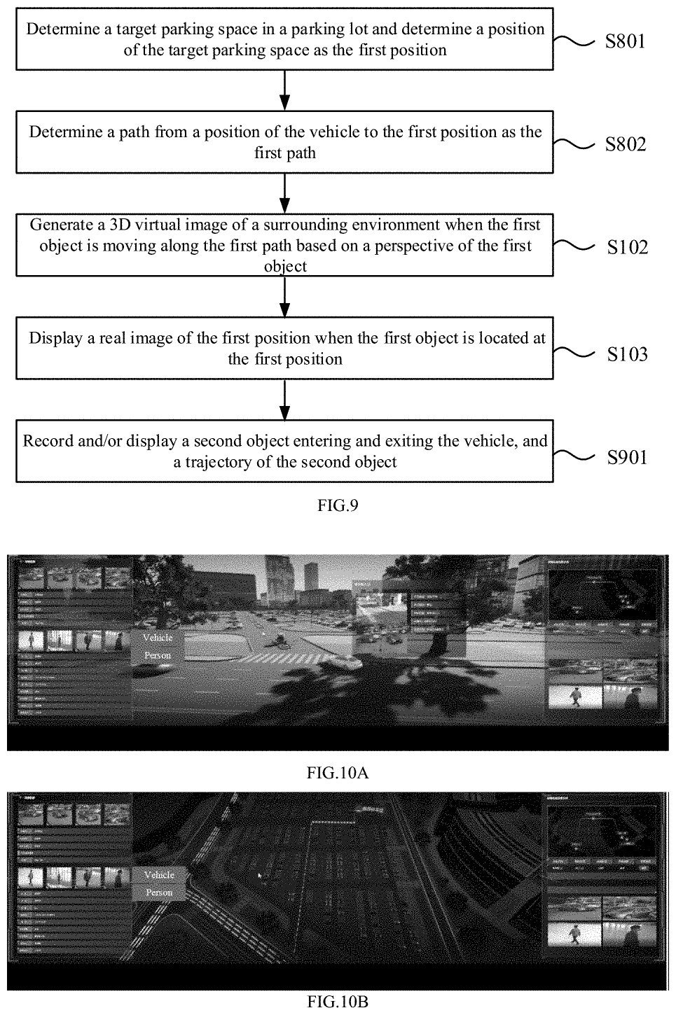

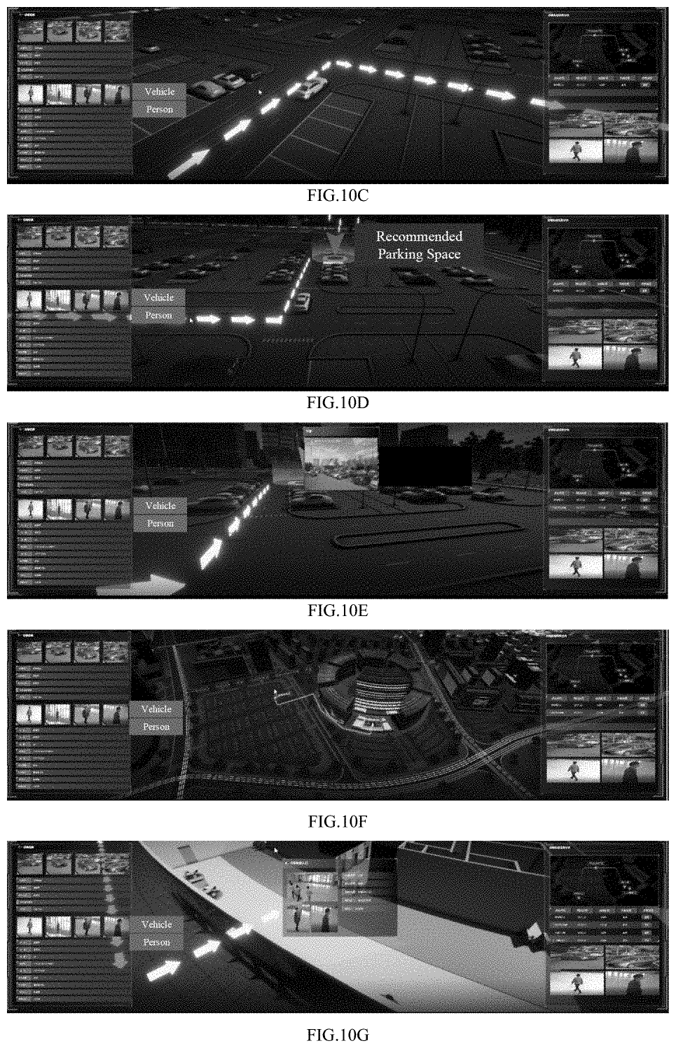

FIGS. 10A to 10G are schematic diagrams illustrating an application scenario according to another embodiment of the present disclosure.

As shown in FIG. 10A, a 3D virtual image at an entrance of the parking lot may be displayed on an interface. When a vehicle is detected, 2D virtual buttons may be displayed on the interface, for example, buttons “Vehicle” and “Person” may be displayed on the left side of the interface, and a real image of the vehicle and specific information of the vehicle such as license plate and vehicle model may also be displayed.

Next, as shown in FIG. 10B, the first position of the target parking space in the parking lot, and a current position of the vehicle may be determined, and then the first path from the position of the vehicle to the first position may be determined, for example, as shown by a dashed line in FIG. 10B. The first path may be sent to the vehicle to provide navigation for the vehicle.

A 3D virtual image of a surrounding environment when the vehicle is moving along the first path may also be generated based on the perspective of the vehicle. When the vehicle is moving along the first path, multi-frame 3D virtual images may be generated continuously, and the continuous multi-frame 3D virtual images may form a 3D video, which is a simulation of a 3D virtual environment viewed from the perspective of the vehicle during the movement of the vehicle along the first path. The generated 3D video may be sent to the vehicle to provide navigation for the vehicle.

During the movement of the vehicle, a 3D virtual image of a surrounding environment when the vehicle is moving along the first path may be generated based on a third perspective. During the movement of the vehicle along the first path, multi-frame 3D virtual images may be generated continuously, for example, as shown in FIG. 10C and FIG. 10D, and the continuous multi-frame 3D virtual images may form a 3D video, which is a simulation of a 3D virtual environment viewed from the third perspective during the movement of the vehicle along the first path, such that the user may view the movement of the vehicle.

Next, when the vehicle is located at the first position, a real image may be fused and displayed in the 3D virtual image of the first position. For example, as shown in FIG. 10E, the real image may be displayed on the basis of the 3D virtual image, such that the user may view a real situation of the vehicle parked in the parking space.

Next, the second object entering and exiting the vehicle and the trajectory of the second object may be recorded and/or displayed. For example, as shown in FIGS. 10F and 10G, the second object is a person, and specific information of the person such as department, name and gender may be identified.

FIG. 11 is a schematic flowchart illustrating a park monitoring method according to yet another embodiment of the present disclosure. As shown in FIG. 11, the method may further include step S1101.

At step S1101, the 3D virtual image of the surrounding environment when the first object is moving along the first path is sent to the first object.

In an embodiment, the generated 3D virtual image of the surrounding environment when the first object is moving along the first path may be a simulation of a 3D virtual environment viewed from the perspective of the first object during the movement of the first object along the first path. By sending the 3D virtual image to the first object, the first object may be provided with navigation so as to accurately move along the first path.

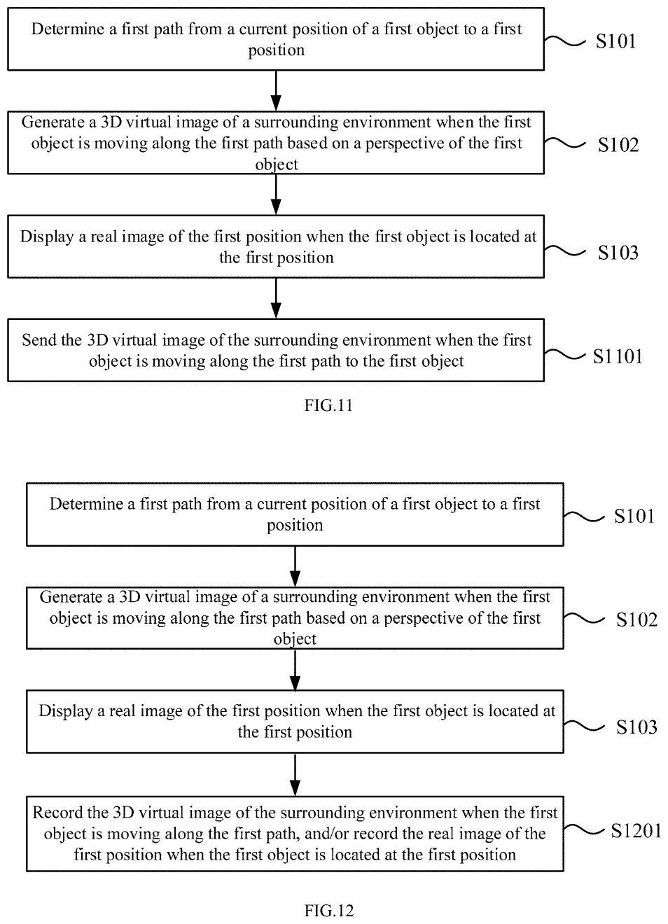

FIG. 12 is a schematic flowchart illustrating a park monitoring method according to yet another embodiment of the present disclosure. As shown in FIG. 12, the method may further include step S1201.

At step S1201, the 3D virtual image of the surrounding environment when the first object is moving along the first path is recorded, and/or the real image of the first position when the first object is located at the first position is recorded.

In an embodiment, the 3D virtual image of the surrounding environment when the first object is moving along the first path may be recorded, and the real image of the first position when the first object is located at the first position may also be recorded. The recorded 3D virtual image and real image may be time-related for subsequent query.

The recorded content may have multiple dimensions, and each dimension may further include multiple sub-dimensions. When viewing the recorded content, the user may operate according to the required dimension or sub-dimension, so as to view the recorded content from that dimension.

For example, the recorded content may include three main dimensions: equipment assets, operation and maintenance personnel, and work order status. Each main dimension may include multiple sub-dimensions.

For example, the main dimension of equipment assets may include three sub-dimensions: list of operation and maintenance work orders, table of equipment operation statuses, and viewing of equipment distribution.

The main dimension of operation and maintenance personnel may include three sub-dimensions: viewing of list of operation and maintenance work orders, viewing of list of operation and maintenance personnel, and viewing of distribution of operation and maintenance personnel.

The main dimension of work order status may include three sub-dimensions: changing curve of operation and maintenance work orders, viewing of list of operation and maintenance work orders, and viewing of distribution of operation and maintenance personnel.

Since the recorded content is time-related, in order to facilitate the query, a timeline may be displayed for the user to operate. A certain time point on the timeline may be clicked, and if there is a recorded content at this time point, the above dimensions may be displayed in addition to the type of the recorded content, which includes, for example, an alarm event such as occupation of a restricted area and equipment abnormalities, and a vehicle entering a parking lot, etc.

For example, if the user chooses an alarm event of equipment abnormalities at that time point, and chooses to view it from the sub-dimension of table of equipment operation statuses, then a 3D virtual image and/or real image of a position of the equipment at that time point may be displayed, and a room where the equipment is located may be highlighted in the 3D virtual image, for example, the room may be displayed in red. Also, specific fault parameters of the equipment such as excess temperature and case damage may be displayed.

For example, if the user chooses an alarm event of equipment abnormalities at that time point, and chooses to view it from the sub-dimension of list of operation and maintenance work orders, then a 3D virtual image may be displayed from the perspective of a handler who handles the alarm event at that time point, and a 3D virtual image of a trajectory of the handler, as well as a real image of the handler dealing with the alarm event may also be displayed.

In addition, the interface may record and display other contents as needed, in addition to displaying the contents in the above embodiments. For example, the interface may record power consumption of each building, the number of users connected to the network, etc., and give different colors to corresponding buildings according to recorded contents for the users to view.

In an embodiment, 3D modeling technology may be used to generate the above-mentioned 3D virtual image.

Building data (for example, buildings, roads, conference rooms, parking lots, office areas, exhibition halls) and spatial position relationships, etc. of the park may be truly restored at a ratio of 1:1 by using CAD vector data in combination with GIS information.

A Unity3D engine may also be used for real-time rendering, providing a variety of interactive methods (for example, mouse, keyboard, touch control, gesture control), providing users with a free interactive experience in a three-dimensional space, allowing the users to view a situation of the park from God's perspective or easily locate an area of interest for micro analysis.

The Internet of Things technology may also be used to obtain data from a variety of intelligent devices, such as camera data (artificial intelligence algorithms may be used to analyze image data in real time to achieve further intelligent functions, such as electronic fences, passenger flow statistics, gesture recognition, and abnormal behavior marking), positioning data, conference room usage status data, and parking lot usage status data, all of which may be uploaded to a cloud platform, and a Message Queuing Telemetry Transport (MQTT) communication protocol may be adopted to realize the subscription/publishing of data messages and achieve real-time display of 3D virtual images.

Intelligent hardware devices (including but not limited to the above-mentioned image capturing devices) all over the park may collect data through the network, and aggregate them to a cloud platform server through the MQTT. These data may be analyzed and processed by artificial intelligence algorithms to generate specific business data. After subscribing through a terminal device, the user may obtain real-time message data push.

An exemplary process may be as follows. A data collecting module collects data from the intelligent devices, uploads it to the cloud platform through the MQTT, and processes it by the artificial intelligence algorithms to generate corresponding business data. A core controller module of a client connects to Broker service of the cloud platform through TCP, and subscribes to related types of business messages. When the Broker service has new data, it will push it to subscribers in real time, and the client may receive the business data generated by processing in real time. After receiving the business data, the core control module may analyze the business data to generate data for different business modules, such as conference room data changes, parking lot data changes, and abnormal alarm information, and then synchronously control refresh of the 2D UI and linkage actions of 3D solid model. A interactive control module captures a user input, analyzes it through the core control module, and triggers a corresponding display effect, which is finally presented on various media such as Windows large screen, Android mobile terminal, and Web page for the users to view anytime and anywhere.

The core control module, after receiving the business data, may analyze the business data to generate data for different business modules. For example, the subscribed business data, after received, may be sorted by Dispatcher and classified into business module data such as conference rooms, office areas, parking lots, visitors and exhibition halls, and other data such as alarms, and then distributed to different sub-processing units. Linkages of the 2D UI and 3D solid model may be displayed through a rendering unit, and finally presented on the terminal.

For example, in an actual usage scenario, a user holds a mobile device and may conveniently query a vacant parking space, book and lock the parking space online, and navigate to the parking space with one button, eliminating the inconvenience of finding parking spaces back and forth. For another example, the user holds the mobile device and may query a vacant conference room, dip into a specific conference room model to check an equipment configuration, book the conference room online, and navigate to the conference room with one button. For yet another example, an intelligent device may capture an abnormal behavior in a restricted area, report it to the cloud platform, then push it to the client, and finally generate a 3D alarm point for display at a corresponding spatial position, which may be clicked by the user to view detailed information, such that the abnormal behavior may be detected and dealt with early, improving operation and management capacity and efficiency of the park.

Corresponding to the foregoing embodiments of the park monitoring method, the present disclosure also provides embodiments related to a park monitoring apparatus.

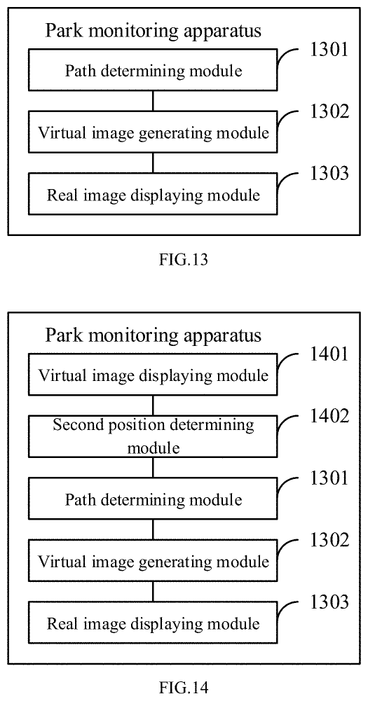

FIG. 13 is a schematic block diagram illustrating a park monitoring apparatus according to an embodiment of the present disclosure. The park monitoring apparatus may be applicable to a park monitoring system. The park monitoring system may be applied to scenarios such as buildings, parking lots, and office parks. The park monitoring system may include a plurality of image capturing devices such as cameras and video cameras. The image capturing devices may be provided at various positions in a scenario, capture images of the various positions in the scenario, and send the captured images to a processor of the park monitoring system. The processor may process the received images, for example, convert the received images into 3D virtual images.

As shown in FIG. 13, the park monitoring apparatus may include:

a path determining module 1301, configured to determine a first path from a current position of a first object to a first position;

a virtual image generating module 1302, configured to generate a 3D virtual image of a surrounding environment when the first object is moving along the first path based on a perspective of the first object; and

a real image displaying module 1303, configured to display a real image of the first position when the first object is located at the first position.

FIG. 14 is a schematic block diagram illustrating a park monitoring apparatus according to another embodiment of the present disclosure. As shown in FIG. 14, the first object is a handler who handles an alarm event, and the apparatus may further include:

a virtual image displaying module 1401, configured to: when the alarm event is detected, display a 3D virtual image of an environment the alarm event is in, and display a mark for the alarm event in the 3D virtual image of the environment the alarm event is in; and when a first command is received, display a 3D virtual image of the first position; and

a second position determining module 1402, configured to determine the handler and a second position of the handler when a second command is received.

Where, the path determining module is configured to determine a path from the second position to the first position as the first path.

Optionally, the virtual image displaying module is configured to determine a second path from a third position where a current monitoring perspective is to the first position; and generate a 3D virtual image of a surrounding environment when moving along the second path based on the current monitoring perspective.

Optionally, the virtual image displaying module is configured to cut, split and enlarge a building where the alarm event is located in the 3D virtual image of the environment the alarm event is in, to display the 3D virtual image of the first position.

FIG. 15 is a schematic block diagram illustrating a park monitoring apparatus according to yet another embodiment of the present disclosure. As shown in FIG. 15, the apparatus may further include:

a trajectory recording module 1501, configured to record a trajectory of the first position when the first position changes with time; and

a position predicting module 1502, configured to determine a third position according to the trajectory, where the third position is a position on the trajectory or a predicted position of the first position.

Where, the path determining module is configured to determine a path from the second position to the third position as the first path.

Optionally, the virtual image generating module may be further configured to determine a target perspective according to the trajectory of the first position; and generate a 3D virtual image of a surrounding environment when moving along the trajectory based on the target perspective.

Optionally, the real image displaying module is configured to fuse the real image of the first position in a 3D virtual image of the first position for display.

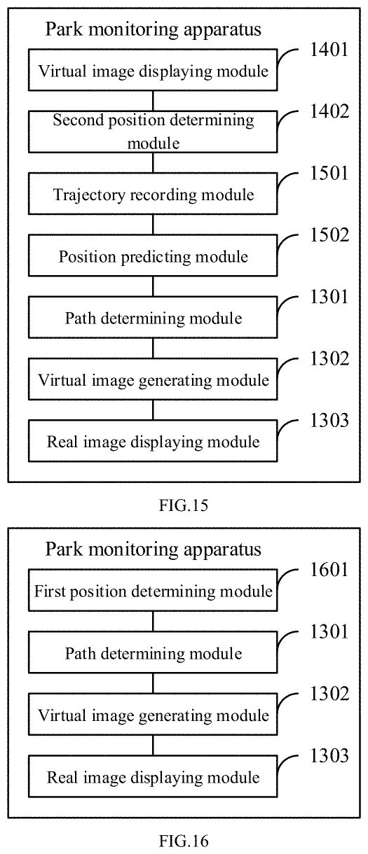

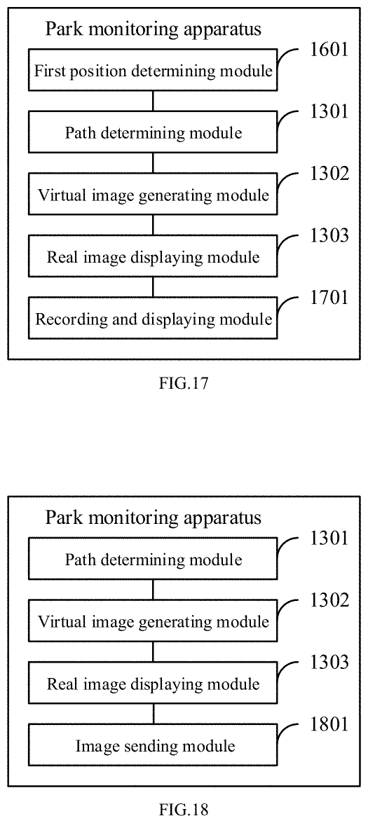

FIG. 16 is a schematic block diagram illustrating a park monitoring apparatus according to yet another embodiment of the present disclosure. As shown in FIG. 16, the first object is a vehicle, and the apparatus may further include:

a first position determining module 1601, configured to determine a target parking space in a parking lot and determining a position of the target parking space as the first position.

Where, the path determining module is configured to determine a path from a position of the vehicle to the first position as the first path.

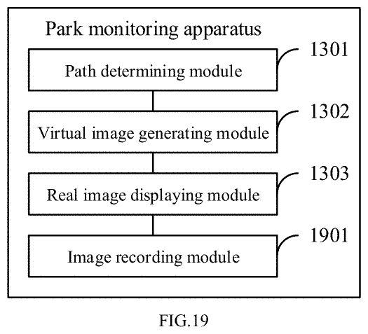

FIG. 17 is a schematic block diagram illustrating a park monitoring apparatus according to yet another embodiment of the present disclosure. As shown in FIG. 17, the apparatus may further include:

a recording and displaying module 1701, configured to record and/or display a second object entering and exiting the vehicle, and a trajectory of the second object.

FIG. 18 is a schematic block diagram illustrating a park monitoring apparatus according to yet another embodiment of the present disclosure. As shown in FIG. 18, the apparatus may further include:

an image sending module 1801, configured to send the 3D virtual image of the surrounding environment when the first object is moving along the first path to the first object.

FIG. 19 is a schematic block diagram illustrating a park monitoring apparatus according to yet another embodiment of the present disclosure. As shown in FIG. 19, the apparatus may further include:

an image recording module 1901, configured to record the 3D virtual image of the surrounding environment when the first object is moving along the first path, and/or record the real image of the first position when the first object is located at the first position.

Embodiments of the present disclosure also provide a park monitoring system, including:

a processor; and

a memory storing programming instructions for execution by the processor to perform the method according to any of the foregoing embodiments.

Embodiments of the present disclosure also provide a non-transitory computer-readable storage medium storing programming instructions for execution by a processor to perform the method according to any of the foregoing embodiments.

In practical applications, the computer-readable storage medium may be any combination of one or more computer-readable media. The computer-readable media may be computer-readable signal media or computer-readable storage media. The computer-readable storage media may be, for example, but not limited to, electrical, magnetic, optical, electromagnetic, infrared, or semiconductor systems, apparatuses or devices, or any combination thereof. More specific examples (a non-exhaustive list) of the computer-readable storage media may include: electrical connections with one or more wires, portable computer disks, hard disks, random access memories (RAMS), read-only memories (ROMs), erasable programmable read-only memories (EPROMs or flash memories), optical fibers, portable compact disk read-only memories (CD-ROMs), optical storage devices, magnetic storage devices, or any suitable combination thereof. In this embodiment, the computer-readable storage media may be any tangible media that contain or store a program, which may be used by or in combination with an instruction execution system, apparatus, or device.

The computer-readable signal media may include data signals propagated in baseband or as a part of a carrier wave, in which computer-readable program codes are carried. The data signals propagated as such may be in many forms, including but not limited to electromagnetic signals, optical signals, or any suitable combination thereof. The computer-readable signal media may also be any computer-readable media other than the computer-readable storage media, which may send, propagate, or transmit the program for use by or in combination with the instruction execution system, apparatus, or device.

The program codes contained in the computer-readable media may be transmitted by any suitable medium, including but not limited to wireless, wire, optical cable, RF, etc., or any suitable combination thereof.

The computer program codes used to perform the operations in the present disclosure may be written in one or more programming languages or a combination thereof. The programming languages may include object-oriented programming languages such as Java, Smalltalk, C++, and also include conventional procedural programming languages such as C language or similar programming languages. The program codes may be executed completely on a user's computer, executed partially on the user's computer, executed as an independent software package, executed partially on the user's computer and partially on a remote computer, or executed completely on the remote computer or server. In the case of the remote computer, the remote computer may be connected to the user's computer through any kind of network, including a local area network (LAN) or a wide area network (WAN), or may be connected to an external computer (for example, through the Internet using an Internet service provider).

In the present disclosure, terms “first” and “second” are only used for descriptive purposes, and cannot be understood as indicating or implying relative importance. Term “a plurality of” refers to two or more, unless specifically defined otherwise.

Those skilled in the art will easily conceive of other embodiments of the present disclosure after considering the specification and practicing the disclosure disclosed herein. The present disclosure is intended to cover any variations, uses or adaptive changes of the present disclosure. These variations, uses or adaptive changes follow the general principles of the present disclosure and include common knowledge or conventional technical means in the art that are not disclosed by the present disclosure. The specification and the embodiments are to be regarded as exemplary only, and the true scope and spirit of the present disclosure are pointed out by the following claims.

1. A park monitoring method, comprising:
determining a first path from a current position of a first object to a first position;
generating a 3D virtual image of a surrounding environment when the first object is moving along the first path based on a perspective of the first object; and
when the first object is located at the first position, displaying a real image of the first position.

2. The method according to claim 1, wherein the first object is a handler who handles an alarm event, and before determining the first path from the current position of the first object to the first position, the method further comprises:
when the alarm event is detected, displaying a 3D virtual image of an environment the alarm event is in, and displaying a mark for the alarm event in the 3D virtual image of the environment the alarm event is in;
when a first command is received, displaying a 3D virtual image of the first position; and
when a second command is received, determining the handler and a second position of the handler, and
wherein, determining the first path from the current position of the first object to the first position comprises:
determining a path from the second position to the first position as the first path.

3. The method according to claim 2, wherein displaying the 3D virtual image of the first position comprises:
determining a second path from a third position where a current monitoring perspective is to the first position; and
generating a 3D virtual image of a surrounding environment when moving along the second path based on the current monitoring perspective, until a 3D virtual image of a surrounding environment at the first position is displayed.

4. The method according to claim 2, wherein displaying the 3D virtual image of the first position comprises:
in the 3D virtual image of the environment the alarm event is in, cutting, splitting, and enlarging a building where the alarm event is located, to display the 3D virtual image of the first position.

5. The method according to claim 2, further comprising:
when the first position changes with time, recording a trajectory of the first position; and
determining a third position according to the trajectory, wherein the third position is a position on the trajectory or a predicted position of the first position; and
wherein, determining the first path from the current position of the first object to the first position comprises:
determining a path from the second position to the third position as the first path.

6. The method according to claim 5, further comprising:
determining a target perspective according to the trajectory of the first position; and
generating a 3D virtual image of a surrounding environment when moving along the trajectory based on the target perspective.

7. The method according to claim 1, wherein displaying the real image of the first position comprises:
fusing the real image of the first position in a 3D virtual image of the first position for display.

8. The method according to claim 1, wherein the first object is a vehicle, and before determining the first path from the current position of the first object to the first position, the method further comprises:
determining a target parking space in a parking lot and determining a position of the target parking space as the first position; and
wherein, determining the first path from the current position of the first object to the first position comprises:
determining a path from a position of the vehicle to the first position as the first path.

9. The method according to claim 8, further comprising:
recording and/or displaying a second object entering and exiting the vehicle, and a trajectory of the second object.

10. The method according to claim 1, further comprising:
sending the 3D virtual image of the surrounding environment when the first object is moving along the first path to the first object.

11. The method according to claim 1, further comprising:
recording the 3D virtual image of the surrounding environment when the first object is moving along the first path, and/or recording the real image of the first position when the first object is located at the first position.

12. A park monitoring system, comprising:
a processor; and
a memory storing programming instructions for execution by the processor to perform operations comprising:
determining a first path from a current position of a first object to a first position;
generating a 3D virtual image of a surrounding environment when the first object is moving along the first path based on a perspective of the first object; and
when the first object is located at the first position, displaying a real image of the first position.

13. The system according to claim 12, wherein the first object is a handler who handles an alarm event, and before determining the first path from the current position of the first object to the first position, the operations further comprise:
when the alarm event is detected, displaying a 3D virtual image of an environment the alarm event is in, and displaying a mark for the alarm event in the 3D virtual image of the environment the alarm event is in;
when a first command is received, displaying a 3D virtual image of the first position; and
when a second command is received, determining the handler and a second position of the handler, and
wherein, determining the first path from the current position of the first object to the first position comprises:
determining a path from the second position to the first position as the first path.

14. The system according to claim 13, wherein displaying the 3D virtual image of the first position comprises:
determining a second path from a third position where a current monitoring perspective is to the first position; and
generating a 3D virtual image of a surrounding environment when moving along the second path based on the current monitoring perspective, until a 3D virtual image of a surrounding environment at the first position is displayed.

15. The system according to claim 13, wherein the operations further comprise:
when the first position changes with time, recording a trajectory of the first position; and
determining a third position according to the trajectory, wherein the third position is a position on the trajectory or a predicted position of the first position; and
wherein, determining the first path from the current position of the first object to the first position comprises:
determining a path from the second position to the third position as the first path.

16. The system according to claim 12, wherein displaying the real image of the first position comprises:
fusing the real image of the first position in a 3D virtual image of the first position for display.

17. The system according to claim 12, wherein the first object is a vehicle, and before determining the first path from the current position of the first object to the first position, the operations further comprise:
determining a target parking space in a parking lot and determining a position of the target parking space as the first position; and
wherein, determining the first path from the current position of the first object to the first position comprises:
determining a path from a position of the vehicle to the first position as the first path.

18. The system according to claim 12, wherein the operations further comprise:
sending the 3D virtual image of the surrounding environment when the first object is moving along the first path to the first object.

19. The system according to claim 12, wherein the operations further comprise:
recording the 3D virtual image of the surrounding environment when the first object is moving along the first path, and/or recording the real image of the first position when the first object is located at the first position.

20. A non-transitory computer-readable storage medium storing programming instructions for execution by a processor to perform operations comprising:
determining a first path from a current position of a first object to a first position;
generating a 3D virtual image of a surrounding environment when the first object is moving along the first path based on a perspective of the first object; and
when the first object is located at the first position, displaying a real image of the first position.
